(19) United States
(12) Patent Application Publication
(10) Pub. No.: US 2010/0018471 A1
(43) Pub. Date: Jan. 28, 2010

(54) Method and Apparatus for Growing Oysters

(76) Inventor: Andrew Murdza, Pasadena, MD (US)

Correspondence Address: Gregory G. Dunn, 3613 Horned Owl Court, Ellicott City, MD, 21042, US

(21) Appl. No.: 12/178,609

(22) Filed: Jul. 24, 2008

(51) Int. Cl. A01K 61/00

(52) U.S. Cl. 119/240

(57) ABSTRACT

A nested pair of perforated containers floats partially submerged in seawater, tethered to a fixed object such as a dock or pier. The inner container is partially filled with oyster spat, closed and laid within the outer container which is then closed and secured. The immature oysters are protected from predators and immersed in the upper 24 inches of seawater where optimum growing conditions exist. Floatation attached to the outer container maintains the top at the water's surface and replaceable filter material around the outside periphery absorbs harmful oils and chemicals. Periodically the inner container is removed, opened and the grown oysters are harvested or dumped onto an oyster bed and the process is repeated.

### BACKGROUND

Many cage type devices have been proposed to increase the yield of intentionally grown oysters. This invention increases the eventual survival and yield over prior art by providing local water filtering and treatment, increased protection from very small predators and optimum placement potential. This invention makes it easy to monitor progress, harvest the grown oysters and clean both containers. Current practice for growing oysters consists of enclosing oyster half-shells with spat attached within coated wire mesh cages and submerged in the bay seawater where a small percentage will grow to maturity. Most of the live spat will be eaten by various predators such as shrimp, flatworms, eels and birds. Enclosing the spat in an inner container protects the spat from all these predators and increases the yield tremendously.

### SUMMARY OF INVENTION

A nested pair of perforated containers floats partially submerged in seawater, tethered to a fixed object such as a dock or pier. The inner container is partially filled with oyster spat, closed and laid within the outer container, which is then closed and secured. The spat then continue to grow within the inner container, protected from predators and immersed in the upper 24 inches of seawater where optimum growing conditions exist. Floatation attached to the outer container maintains the almost completely submerged position and replaceable filter material around the outside periphery absorbs harmful oils and chemicals. Periodically the inner container is removed, opened and the grown oysters are harvested or dumped onto an oyster bed and the process is repeated.

### DRAWINGS

The various objects and features of this invention will be fully understood from the following detailed description of the typical preferred form and application thereof, throughout which description reference is made to the accompanying drawings, in which:

FIG. 1 is a front view of the Oyster Hotel with cover open

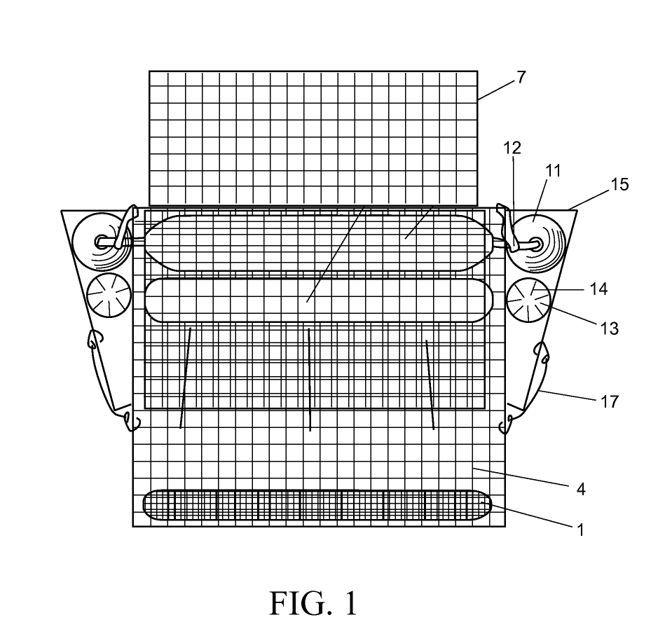

FIG. 2 is a side view of the Oyster Hotel with cover open

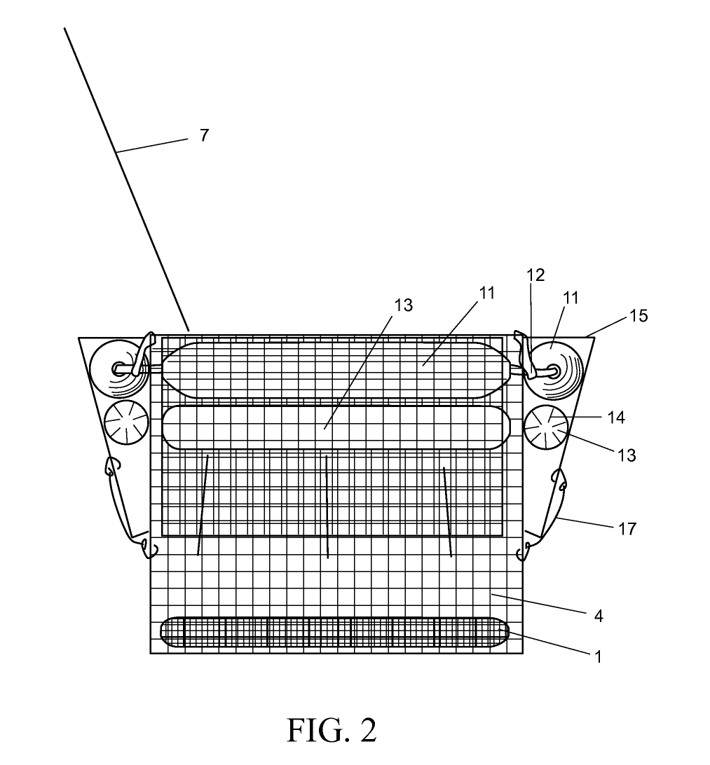

FIG. 3 is a top view of the Oyster Hotel with cover closed

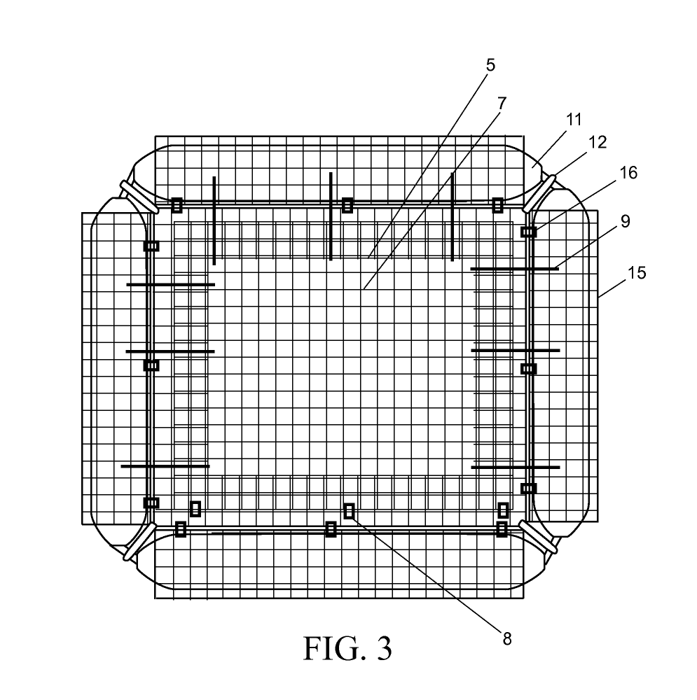

FIG. 4 is a bottom view of the Oyster Hotel

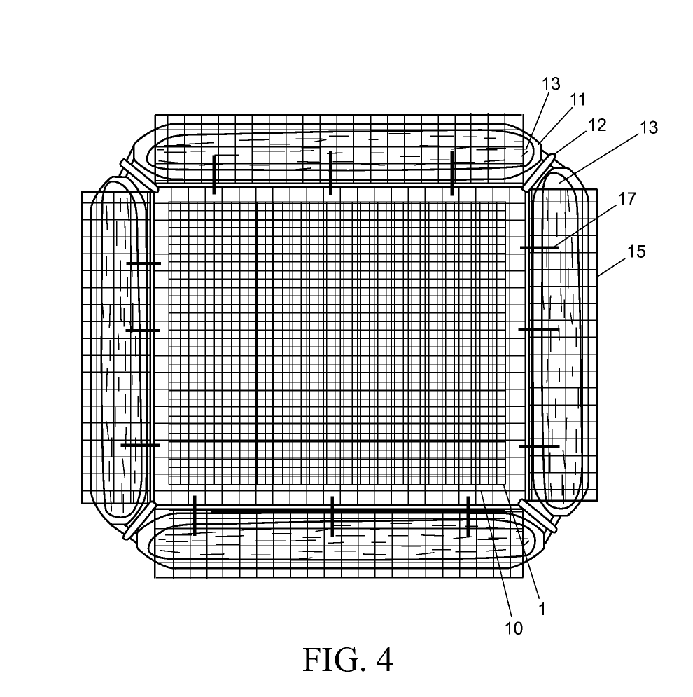

FIG. 5 is a top perspective view of the inner container 1

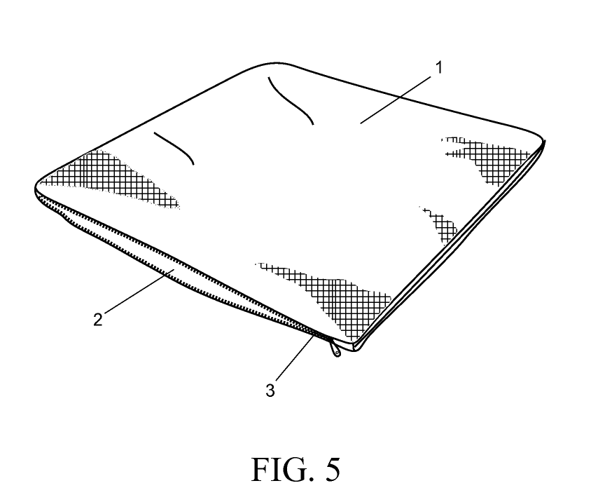

### PREFERRED EMBODIMENT

Inner perforated container 1 is a mesh bag with at least one opening 2 at one side to allow oyster spat to be inserted therein and sealed closed by a fastener such as a corrosion resistant zipper 3. This inner container is inserted into an outer perforated container 4 through an opening 5 in its top surface 6 which is then sealed by top cover 7. Top cover 7 is hinged to outer container 4 along one of the top cover's edges by hinge rings 8 and held closed by elastic bands 9. Inner container 1 lies on the lower surface 10 of outer container 4. Outer container 4 is caused to be buoyant in seawater by floats 11 secured around the upper perimeter of outer container 4 by ropes 12 attached to outer container corners. These ropes also serve to anchor the outer container to a fixed object such as a pier or dock. Floats 11 and filter material 13 which could be composed of barley straw contained in a polymer mesh tube 14 are both contained within filter enclosures 15 which are attached to the upper horizontal edges of the vertical side surfaces of outer container 4 by means of corrosion resistant rings 16 which act as hinges that allow filter enclosures 15 to swing outward enabling placement and replacement of filter material 13 as needed. Filter enclosures 15 are held closed by elastic bands 17 stretched between filter enclosure 15 and the lower portion of outer container 4.

### Method

Referring now to this method of increasing the survival rate for growing oysters from tiny immature organisms to maturity, the inner container is filled with oyster spat, placed inside the outer container where it rests upon the bottom surface of the outer container. The whole system is tethered in seawater in a desirable location for further growth of the immature oysters to releasable size. Maximum production is achieved by allowing the oysters to grow in the top twenty four inches of the seawater where nutrients and sunlight are concentrated and the immediate water surrounding the oysters is filtered of oils and chemicals. The double container protection rejects all predators commonly encountered in this endeavor. This system provides for ease of maintenance and observation.

I claim:

1. An openable perforated enclosure completely contained within a second openable buoyant perforated enclosure intended to float in water with a means of securing a filter material around a portion of the outer container's periphery and a means for securing the outer container to a fixed object nearby.

2. The enclosure in claim 1 where the inner enclosure is composed of a fine mesh material such as metal or polymer where at least one end can be opened and closed to allow objects to be inserted into and removed from within.

3. The enclosure in claim 2 where the inner enclosure is generally shaped as a flat closable bag that lies fully extended within and on the bottom of the outer enclosure.

4. The enclosure in claim 3 where the inner enclosure has a corrosion resistant zipper on at least one end.

5. The enclosure in claim 4 where the outer perforated container has integral chambers suitable for securing floatation devices.

6. The enclosure in claim 5 where the outer perforated container has integral chambers suitable for securing filter material

7. The enclosure in claim 6 where the filter chambers are openable outward to allow replacement of the filter material.

8. The enclosure in claim 7 where the filter material is barley grass enclosed cylindrical polymer mesh containers.

9. The enclosure in claim 6 where the outer container has six flat sides.

10. The enclosure in claim 9 where the float chambers are equally distributed along the top of 4 vertical sides so that the entire top surface of the outer container floats at or near the water surface and the bottom surface of the outer container is approximately 24 inches below the water surface.

11. The enclosure in claim 10 where the outer container is composed of corrosion resistant mesh.

12. The enclosure in claim 11 where the outer container has an openable portion of its top surface.

13. The enclosure in claim 12 where the openable portion is hinged at one edge and held closed by elastic material.

14. The enclosure in claim 13 where the outer enclosure is composed of coated wire 1 inch mesh.

15. The enclosure in claim 3 where the outer perforated container is composed of naturally buoyant material with sufficient buoyancy to allow the top surface of the outer container to float at or near the water's surface.

16. The enclosure in claim 15 where the perforations are of sufficient size and number to allow free exchange of seawater through outer container walls.

17. The enclosure in claim 16 where the outer container has an openable portion of its top surface.

18. The enclosure in claim 17 where the openable portion is hinged at one edge and held closed by elastic material.

19. The enclosure in claim 18 where the outer enclosure has integral filter chambers partially encircling the outer enclosure just below the water's surface and that are openable outward to allow replacement of the filter material.

20. The enclosure in claim 19 where the filter material is composed of barley grass enclosed cylindrical polymer mesh containers.

21. The enclosure in claim 17 where the outer perforated enclosure has six flat sides

22. The enclosure in claim 17 with a means to attach filter material directly to the vertical sides below the water level.
